(19) United States
(12) Patent Application Publication
(10) Pub. No.: US 2025/0284990 A1
(43) Pub. Date: Sep. 11, 2025

(54) Systems And Methods for Quantum Linear Prediction

(71) Applicants: Andreas SPANIAS, Tempe, AZ (US); Aradhita SHARMA, Tempe, AZ (US); Glen UEHARA, Gilbert, AZ (US)

(72) Inventors: Andreas SPANIAS, Tempe, AZ (US); Aradhita SHARMA, Tempe, AZ (US); Glen UEHARA, Gilbert, AZ (US)

(73) Assignee: Arizona Board of Regents on Behalf of Arizona State University, Tempe, AZ (US)

(21) Appl. No.: 18/936,643

(22) Filed: Nov. 4, 2024

Related U.S. Application Data
(60) Provisional application No. 63/595,993, filed on Nov. 3, 2023.

(51) Int. Cl. G06N 10/20; G06N 10/60

(52) U.S. Cl. CPC G06N 10/20; G06N 10/60

(57) ABSTRACT

Systems and methods for quantum linear prediction include autocorrelations formed with QFTs, and a modified quantum HHL circuit that includes appropriate normalization and encoding steps for solving a linear system of equations, including normalization of the quantum autocorrelation sequence using a norm factor; measuring a probabilistic distribution associated with values of a quantum state solution vector representing a set of quantum autoregressive parameters that correlate with a linear relationship between the quantum autocorrelation matrix and the quantum autocorrelation sequence; and generating a set of quantum linear prediction coefficients by re-normalization of the quantum state solution vector using the norm factor associated with the quantum autocorrelation sequence of the preprocessed input.

### CROSS-REFERENCE TO RELATED APPLICATIONS

This is a U.S. Non-Provisional patent application that claims benefit to U.S. Provisional Patent Application Ser. No. 63/595,993 filed 3 Nov. 2023, which is herein incorporated by reference in its entirety.

### FIELD

The present disclosure generally relates to quantum computing and signal processing; and in particular to systems and methods for quantum linear prediction.

### BACKGROUND

Quantum computing has the potential to significantly impact massive signal processing operations. Research is being done in exploring ways to harness its potential for signal processing applications. In particular, it is believed that existing classical linear prediction algorithms have computation drawbacks.

It is with these observations in mind, among others, that various aspects of the present disclosure were conceived and developed.

### SUMMARY

The present technology describes a novel approach for the development of quantum linear prediction (QLP). An algorithm is developed using quantum Fourier transforms to obtain the correlation of the signal and the modified HHL algorithm for solving a linear system of equations, to potentially achieve a faster computation compared to the classical algorithm. A novel quantum algorithm is described for computing linear prediction. A 4th order quantum linear predictor circuit is also disclosed, as well as a novel normalization and denormalization process.

In some illustrative examples, the inventive concept herein can take the form of a method for quantum linear prediction, including steps of performing voice activity detection on an input speech signal; dividing a voiced segment of the input speech signal into a plurality of frames; applying a windowing function to the plurality of frames to tape a start and end of each frame and minimize spectral leakage and generate a plurality of windowed frames from the plurality of frames; normalizing each of the plurality of windowed frames; encoding each of the plurality of windowed frames as quantum states to derive a quantum encoded speech signal; passing the quantum encoded speech signal to a quantum autocorrelation system to estimate a quantum autocorrelation sequence; constructing a quantum autocorrelation matrix from the quantum autocorrelation sequence; preprocessing the quantum autocorrelation matrix and quantum autocorrelation sequence as b vector to generate a preprocessed input; passing the preprocessed input to a quantum HHL circuit measured to obtain results defined as |x>_{measured} quantum state; and post processing the results to define a quantum linear prediction (QLP) coefficients (quantum AR parameters).

Other examples and example features include:
A novel quantum algorithm is developed for computing linear prediction.
A 4th-order quantum linear predictor circuit is designed and evaluated.
A novel normalization and denormalization methods are developed
A 4th order quantum DPCM system is demonstrated for speech analysis syntheses applications
An Adaptive quantum linear prediction methods using the interpolation is developed.
A Modified HHL algorithm is developed and configured for speech analysis using linear prediction.
A Quantum system is presented for system identification using QLP.
A Quantum system is presented for spectral estimation using QLP.
A Quantum system is presented for speech analysis synthesis using QLP.

The foregoing examples broadly outline various aspects, features, and technical advantages of examples according to the disclosure in order that the detailed description that follows may be better understood. It is further appreciated that the above operations described in the context of the illustrative example method, device, and computer-readable medium are not required and that one or more operations may be excluded and/or other additional operations discussed herein may be included. Additional features and advantages will be described hereinafter. The conception and specific examples illustrated and described herein may be readily utilized as a basis for modifying or designing other structures for carrying out the same purposes of the present disclosure. Such equivalent constructions do not depart from the spirit and scope of the appended claims.

### BRIEF DESCRIPTION OF THE DRAWINGS

FIG. 1A is a simplified diagram showing a system for extracting a set of quantum linear prediction coefficients from an input signal.

FIG. 1B is a simplified block diagram showing an example sequence for extracting a quantum autocorrelation sequence from an input signal using the system of FIG. 1A.

FIG. 2 is a simplified block diagram showing an example sequence for extracting a quantum autocorrelation sequence from an input signal for implementation of the system of FIG. 1A.

FIG. 3 is a schematic diagram showing a Harrow-Hassidim-Lloyd (HHL) quantum circuit described herein.

FIGS. 4A-4C are a series of process flow diagrams showing a method outlined herein for extracting a set of quantum linear prediction coefficients from an input signal.

FIG. 5 is a simplified block diagram showing an example computing device which can implement aspects of the system of FIG. 1A and the method of FIGS. 4A-4C.

FIGS. 6A and 6B are a pair of graphical representations illustrating magnitude v. frequency plots for different responses for system identification.

FIGS. 7A and 7B are a pair of graphical representations illustrating magnitude spectrum v. frequency plots for spectral estimation using quantum linear prediction (QLP) and classical linear prediction (CLP).

FIGS. 8A and 8B are a pair of graphical representations illustrating speech analysis synthesis using QLP and CLP.

Corresponding reference characters indicate corresponding elements among the view of the drawings. The headings used in the figures do not limit the scope of the claims.

### DETAILED DESCRIPTION

The present disclosure relates to examples of systems and methods for quantum linear prediction that uses autocorrelations formed with QFTs, and a modified pre- and post-processing scheme paired with a quantum Harrow-Hassidim-Lloyd (HHL) circuit that includes appropriate normalization and encoding steps.

### INTRODUCTION

Quantum computing has the potential to significantly impact massive signal processing operations. Research is being done in exploring ways to harness its potential for signal processing applications. However, the application of linear prediction using quantum computing has not been previously addressed. The use of quantum computing for signal processing holds great promise for improving the speed and accuracy in several signal processing applications including linear prediction of speech and other signals. This disclosure describes a novel approach for the development of quantum linear prediction (QLP). The algorithm is developed using quantum Fourier transforms for obtaining the correlation of the signal and supports use of a HHL circuit for solving a linear system of equations, to potentially achieve a faster computation compared to the classical algorithm.

More specifically, the present disclosure outlines systems and methods for quantum linear prediction using quantum autocorrelation, and a modified pre- and post-processing scheme for use with a quantum HHL circuit that includes appropriate normalization and encoding steps. The developed systems and methods for quantum linear prediction are analyzed for various signal processing applications such as system identification, spectral estimation, and analysis-synthesis of speech signals. The effectiveness of the system outlined herein for quantum linear prediction is compared to the existing classical linear prediction for these applications. Also, the quantum Autoregressive (AR) parameters are adapted to every speech frame using a weighted interpolation technique for adaptive quantum linear prediction. Qubit precision and quantum noise effects are further examined, and the resultant quantum linear prediction results are compared with the classical results.

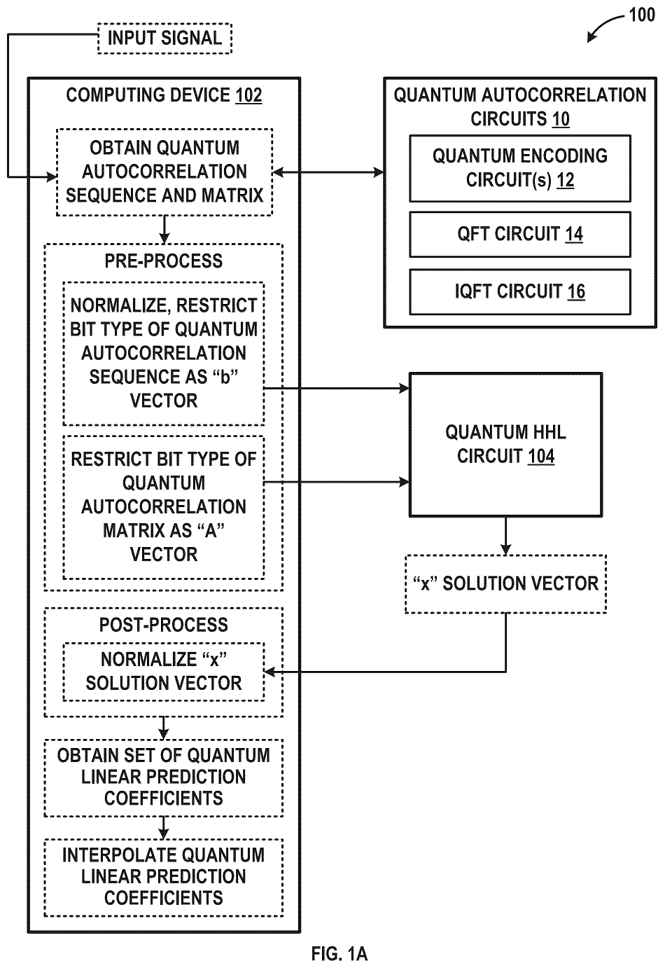

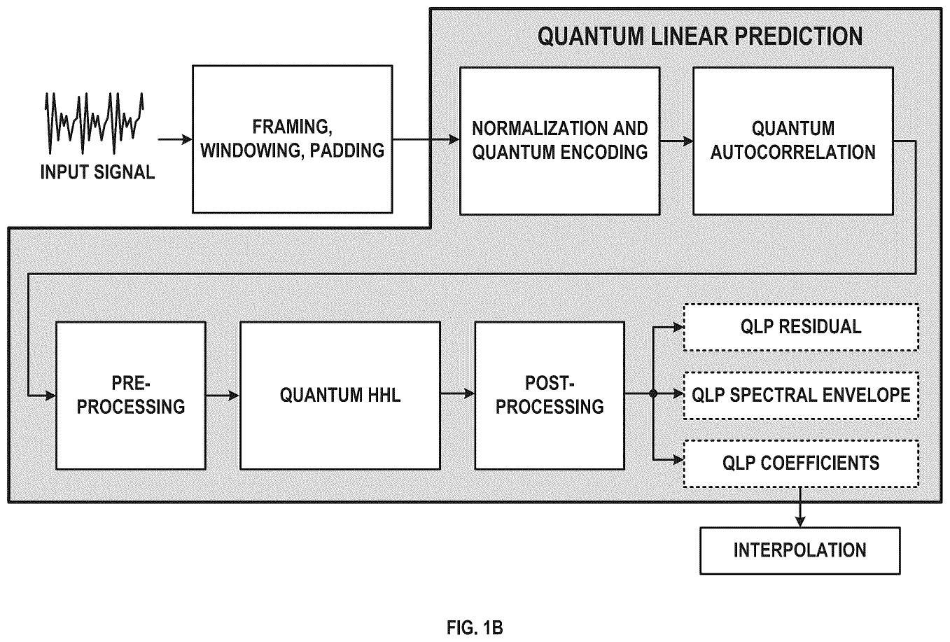

FIGS. 1A and 1B show an overview of a system 100 for extracting quantum linear prediction coefficients from an input signal. The input signal can include, for example, a speech signal or another type of audio signal. The input signal could also include image or video signals (e.g., where each pixel needs a quantum signal representation). Further, the input signal could include other types of “big data” where there is a large quantity of data to process.

As shown in FIG. 1A, the system 100 can include a computing device 102 which can be a classical computing device or a quantum computing device. The computing device 102 can communicate with various quantum circuits which can perform tasks including measuring a probabilistic distribution associated with values of a quantum state solution vector (e.g., to solve a linear system of equations that relate a quantum autocorrelation sequence and its corresponding quantum autocorrelation matrix with a set of quantum linear prediction coefficients). As such, the system 100 can include a Quantum Harrow-Hassidim-Lloyd (HHL) circuit 104.

In addition, in order to obtain the autocorrelation sequence for the input signal, the system can include or otherwise communicate with quantum circuits that can perform tasks such as quantum encoding, evaluating a Quantum Fourier Transform (QFT), and evaluating an Inverse Quantum Fourier Transform (IQFT). These are shown in FIG. 1A as quantum autocorrelation circuits 10, which can include quantum encoding circuits 12, a QFT circuit 14, and an IQFT circuit 16.

The system 100 can preprocess a quantum autocorrelation matrix and a quantum autocorrelation sequence associated with an input signal to generate a preprocessed input. The quantum autocorrelation matrix and the quantum autocorrelation sequence can be obtained using quantum autocorrelation circuits 10. Preprocessing can include normalization of the quantum autocorrelation sequence using a norm factor. Further, preprocessing can include restricting the quantum autocorrelation matrix to be of complex64 bit representation and restricting the quantum autocorrelation sequence to be of float64 bit representation.

The system 100 can further measure, by application of the preprocessed input to the Quantum HHL circuit 104, a probabilistic distribution associated with values of a quantum state solution vector. The preprocessed input includes the preprocessed quantum autocorrelation sequence (as “b” vector) and the preprocessed quantum autocorrelation matrix (as “A” matrix). The quantum state solution vector (as “x” vector) represents a set of quantum autoregressive parameters that correlate with a linear relationship between the quantum autocorrelation matrix (“A” matrix) and the quantum autocorrelation sequence (“b” vector), e.g., such that Ax=b.

The system 100 can generate a set of quantum linear prediction coefficients by re-normalization of the quantum state solution vector (“x” vector) using the norm factor associated with the quantum autocorrelation sequence (“b” vector) of the preprocessed input, in addition to a Euclidean norm and a linear norm as outlined in further detail herein.

The system 100 (or another downstream component) can use the set of quantum linear prediction coefficients for a downstream task. In some examples, the system 100 can interpolate the set of quantum linear prediction coefficients by modification of a quantum linear prediction coefficient for a current frame based on one or more quantum linear prediction coefficients associated with one or more previous frames and a weightage ratio. The system 100 may also obtain values such as a quantum linear prediction residual and/or a spectral envelope. The set of quantum linear prediction coefficients can be used for tasks such as but not limited to file compression, speech recognition and interpretation, and voice enhancement. Quantum signal processing can be particularly helpful for massive datasets

Importantly, to compensate for unique challenges posed by using quantum computing to obtain the set of quantum linear prediction coefficients, the system 100 employs normalization and de-normalization steps to ensure that quantum measurement results are comparable to ranges that would be obtained with classical autocorrelation computation methods.

### Quantum Autocorrelation

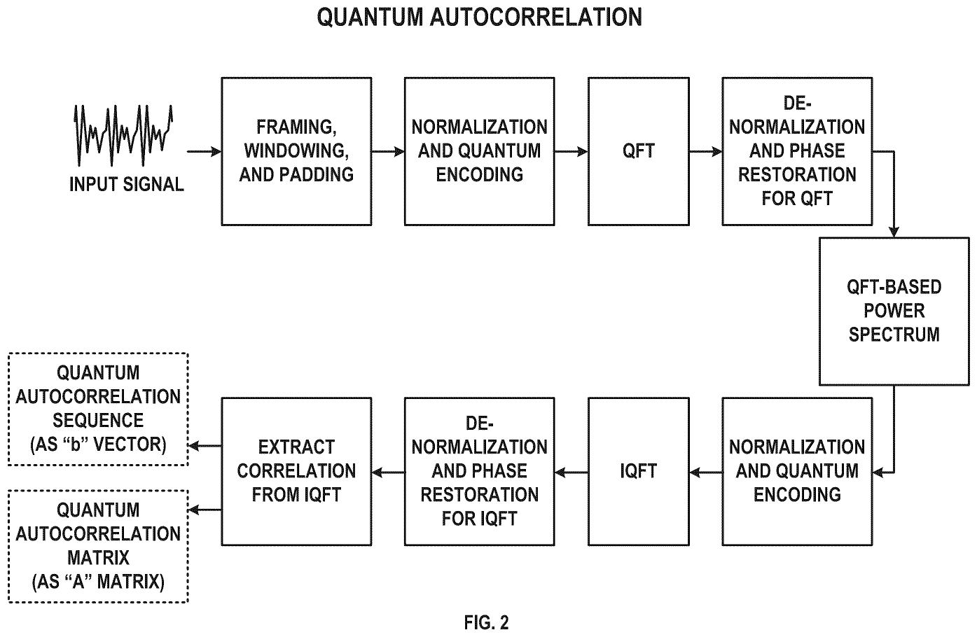

FIG. 2 shows a quantum autocorrelation computation based on the QFT as follows.

For calculating the quantum autocorrelation of a signal using QFTs, the input signal is preprocessed by framing, overlapping, windowing and padding. This preprocessed frame signal is normalized to be quantum encoded as a first quantum state using linear norm as follows.

$$norm = \sqrt{{\sum }_{n = 0}^{N - 1} {{α}_{n}}^{2}} \qquad ( 1 )$$

Following normalization, the quantum encoding circuit 12 can encode the input signal into the first quantum state. The first quantum state is passed as input to the QFT circuit 14 which can measure a probabilistic distribution (Pₙ) associated with a frequency-domain representation of the first quantum state. Further, de-normalized QFT coefficients are obtained by performing de-normalization after post-measurement. The power spectrum (Sₖ) of the signal is calculated by multiplying the obtained QFT coefficients with its complex conjugate.

$${S}_{k} = {QFT}_{n} {QFT}_{n}^{*} \qquad ( 2 )$$

The obtained QFT-based power spectrum is normalized, and quantum-encoded into a second quantum state using a quantum encoding circuit 12 (which may be a second quantum encoding circuit dedicated to computing the second quantum state). Then, the second quantum state is applied as input to the IQFT circuit 16. De-normalization is performed post-measurement to obtain de-normalized IQFT coefficients which are used to extract the quantum autocorrelation sequence rₓ(τ).

$${r}_{x} ( τ ) = IQFT \vert {S}_{k} 〉 \qquad ( 3 )$$

Based on the quantum autocorrelation sequence obtained, an autocorrelation matrix Rₓ is constructed as:

$${R}_{x} = [ \begin{matrix}{r}_{x} ( 0 ) & {{r}_{x}}^{*} ( 1 ) & ⋯ & {{r}_{x}}^{*} ( p ) \\ {r}_{x} ( 1 ) & {r}_{x} ( 0 ) & ⋯ & {{r}_{x}}^{*} ( p - 1 ) \\ ⋮ & ⋮ & ⋱ & ⋮ \\ {r}_{x} ( p ) & {r}_{x} ( p - 1 ) & ⋯ & {r}_{x} ( 0 )\end{matrix} ] \qquad ( 4 )$$

The resulting quantum autocorrelation sequence is then used to calculate the quantum linear prediction coefficients.

### The Quantum HHL Algorithm

The Harrow-Hassidim-Lloyd (HHL) algorithm is a quantum based algorithm that solves a linear system of equations (described in Harrow, Aram W., Avinatan Hassidim, and Seth Lloyd. “Quantum algorithm for linear systems of equations.” Physical review letters 103.15 (2009): 150502; herein incorporated by reference in its entirety). The HHL algorithm utilizes quantum techniques including quantum superposition and quantum Fourier transform and provides speedup for matrix inversion tasks relative to other methods (see Hestenes, Magnus R., and Eduard Stiefel. “Methods of conjugate gradients for solving linear systems.” Journal of research of the National Bureau of Standards 49.6 (1952): 409-436, incorporated by reference in its entirety). The schematic of the HHL algorithm is described in FIG. 2.

A linear system of the equations can be written in matrix equation form as Ax=b, where A is an N×N matrix that includes coefficients of the linear system (e.g., the autocorrelation matrix Rₓ), b is a column vector that can include constant terms (e.g., the quantum autocorrelation sequence), and x is a column vector that includes an unknown solution to the linear system.

$$A = [ \begin{matrix}{A}_{11} & {A}_{12} & ⋯ & {A}_{1 N} \\ {A}_{21} & {A}_{22} & ⋯ & {A}_{2 N} \\ ⋮ & ⋮ & ⋱ & ⋮ \\ {A}_{N 1} & {A}_{N 2} & ⋯ & {A}_{NN}\end{matrix} ] , x = [ \begin{matrix}{x}_{0} \\ {x}_{1} \\ ⋮ \\ {x}_{N - 1}\end{matrix} ] , b = [ \begin{matrix}{b}_{0} \\ {b}_{1} \\ ⋮ \\ {b}_{N - 1}\end{matrix} ] \qquad ( 5 )$$

For solving the system of linear equations using quantum computing, the A matrix must be a Hermitian matrix. Representing the vector b using n_{b}=log N qubits as a quantum state, |b [symbol] =Σⱼ₌₀^{N-1}bⱼ|j [symbol] normalized using norm_{b} such that Σⱼ₌₀^{N-1}|bⱼ|²=1. After applying the Hamiltonian e^{iAt} to |b [symbol] , phase estimation technique is applied to calculate the eigenvalues λⱼ and eigen vectors |uⱼ [symbol] of A matrix and to decompose |b [symbol] =Σⱼ₌₀^{N-1}βᵢ|uⱼ [symbol] . The uncomputation is performed such that the state of the system becomes equal to the following.

$${\sum }_{j = 0}^{N - 1} {β}_{i} {{λ}_{j}}^{- 1} \vert {u}_{j} 〉 = {A}^{- 1} \vert b 〉 = \vert x 〉 . \qquad ( 6 )$$

This results in the quantum representation |x [symbol] _{measured} of the solution vector x which is obtained after the measurement described in Harrow et al. (see Harrow, Aram W., Avinatan Hassidim, and Seth Lloyd. “Quantum algorithm for linear systems of equations.” Physical review letters 103.15 (2009): 150502., incorporated by reference in its entirety). The elaborated steps for constructing HHL quantum circuit is explained in Morell Jr. et al. (Morrell Jr, Hector Jose, Anika Zaman, and Hiu Yung Wong. “Step-by-step hhl algorithm walkthrough to enhance the understanding of critical quantum computing concepts.” arXiv preprint arXiv: 2108.09004 (2021), incorporated by reference in its entirety).

### Novel Pre and Post Processing of Speech Signals for the HHL Computations

When working with speech signals and finding the solution of linear autocorrelation equations representing speech signals, there are several necessary steps to solve normalization and quantum encoding problems so that the end results are comparable to ranges that may be obtained using classical methods (but with the added benefits of quantum methods such as speed and reduced computational complexity). While a conventional HHL algorithm can theoretically handle dense matrices, it is seen that the calculation of the solution for dense matrices using HHL has limited efficiency and accuracy. As the size of the matrix increases, the depth and complexity of the quantum circuit increases. And as the matrix becomes dense, the circuit depth grows exponentially, with more complex entanglement patterns of qubits making it challenging to implement an algorithm for high-order systems.

Therefore, the present disclosure outlines a novel pre- and post-processing structure for calculating the solution (e.g., vector x) associated with the autocorrelation matrix representing speech signals. Firstly, the 16-bit signed input speech signal is normalized to the range [−1,1] floating point representation to simplify the subsequent processing steps. Next, the b vector is normalized prior to encoding as a quantum state in the Quantum HHL circuit 104. The A matrix and b vector can be restricted to complex64 and float64 bit representations (respectively) with an attempt of reducing complex entanglement patterns such that computations are performed in memory constrained requirements. However, in some examples this may result in a loss of bit precision in representing numerical values, which can result in rounding errors that are carried through the Quantum HHL circuit 104.

Since the measurement of quantum circuits results in probabilistic values, a postprocessing structure is developed to make the quantum solution in alignment with classical solution for the linear system of equations. Since the b vector had been normalized prior to encoding as a quantum state, the quantum solution x must also be normalized by considering norm_{b}. Also, the measured quantum solution x needs to be re-normalized using linear norm and Euclidean norm (to include the probability of measuring ancilla qubit as 1) to obtain the HHL solution close to the classical solution.

$${LPC = \vert x 〉}_{measured} * \frac{Euclidean Norm}{Linear Norm} * {norm}_{b} \qquad ( 7 )$$

FIG. 1A shows pre- and post-processing structures associated with the Quantum HHL circuit 104. With this modified approach, quantum linear prediction can be more efficiently implemented for speech processing applications.

As the size of the autocorrelation matrix is increased to an 8×8 matrix, the circuit depth is grown exponentially, and the available memory capacity exceeds while computing. One idea to build an 8th-order quantum linear predictor is by utilizing a matrix inversion lemma to find the inverse of an 8×8 matrix by calculating the inverse of 4×4 submatrices using quantum matrix inversion. However, low order linear prediction is common in ADPCM (Adaptive Differential Pulse Code Modulation) processing of speech. ADPCM employs short-term linear prediction analysis synthesis with low computational complexity and achieves lower bitrate representations, it was considered to develop the short-term QLP which captures the short-term quantum correlation of the signal. Therefore, a 4th-order quantum linear predictor is developed for short-term quantum linear prediction with applications to ADPCM. As mentioned before, higher order quantum linear predictors can be developed possibly using the partitioned form of the matric inversion Lemma (see A. Spanias, Ted Painter, and Venkatraman Atti. Audio signal processing and coding. John Wiley & Sons, 2006., incorporated by reference in its entirety).

### Quantum Linear Prediction

A quantum linear prediction algorithm was developed using quantum autocorrelation and quantum HHL algorithm for quantum inversion solution similar to the classical linear prediction using autocorrelation method. FIGS. 1A and 1B show a simplified overview of showing quantum linear prediction for speech signals, further explained as follows.

Frame segmentation and Windowing: Voice activity detection is performed on the input speech signal, and only the voiced segment of speech is selected. The selected speech signal is divided into smaller segments called frames, ranging from N=32 to 128 samples assuming that the speech signal remains stationary within each frame. After that, a windowing function is applied to each frame to smoothly taper the starting and end of the frame and minimize spectral leakage.

Novel Quantum Speech Encoding: For each windowed frame, the frame values are normalized and encoded as quantum states.

Quantum Autocorrelation Sequence: The quantum encoded speech signal is passed to the quantum autocorrelation system to estimate the quantum autocorrelation sequence which is used to construct the quantum autocorrelation matrix. This matrix is of N×N size, where N is the order of the autoregressive model.

Quantum HHL: Once the autocorrelation matrix is obtained, the matrix and autocorrelation sequence as b vector are preprocessed. For the N×N size matrix, the number of qubits used are n_{b}+N+1=m qubits, with total 2^{m} quantum basis states, and the preprocessed input is passed to the quantum HHL circuit. The circuit is measured to obtain |x [symbol] _{measured} quantum state and the results are post processed to make them aligned to classical implementation. The post processed results are the quantum linear prediction (QLP) coefficients (quantum AR parameters).

Along with QLP coefficients, AR model gain is also calculated, by matching the energy of the input signal with the energy of quantum linear predicted samples, allowing accurate analysis and synthesis.

### Interpolation of Quantum Linear Prediction Coefficients for Adaptive Prediction

In speech processing, transition segments can exhibit variations in spectral characteristics within a short time interval. Because of these transitions, abrupt shifts are seen in LPCs across consecutive speech frames leading to abruptness in synthesized speech. Interpolation allows for a smooth variation of interpolated AR parameters as a function of time, which helps in maintaining the quality of the synthesized speech. In this research, the weighted interpolation technique can be used to achieve a smooth transition of quantum linear prediction coefficients. The interpolation is performed such that more weightage is given to the QLPCs of the current frame and less weightage to the QLPCs of the previous frame, ensuring a stronger influence of the current frame's characteristics on interpolated coefficients, while keeping the continuity from previous frames. The QLP coefficients (aₖ^{q})ₙ of the current frame n are modified based on the current frame and previous frame coefficients (aₖ^{q})ₙ₋₁ with w weightage ratio given to the current frame as follows

$${( {a}_{k}^{q} )}_{n} = w * {( {a}_{k}^{q} )}_{n} + ( 1 - w ) * {( {a}_{k}^{q} )}_{n - 1} \qquad ( 8 )$$

This interpolation process allows for adaptation of QLPCs, enabling the quantum AR model to adapt to variations, resulting in adaptive prediction (|w|<1). Other forms of interpolations have been used in CELP type algorithms and can be applied here as well.

### Methods

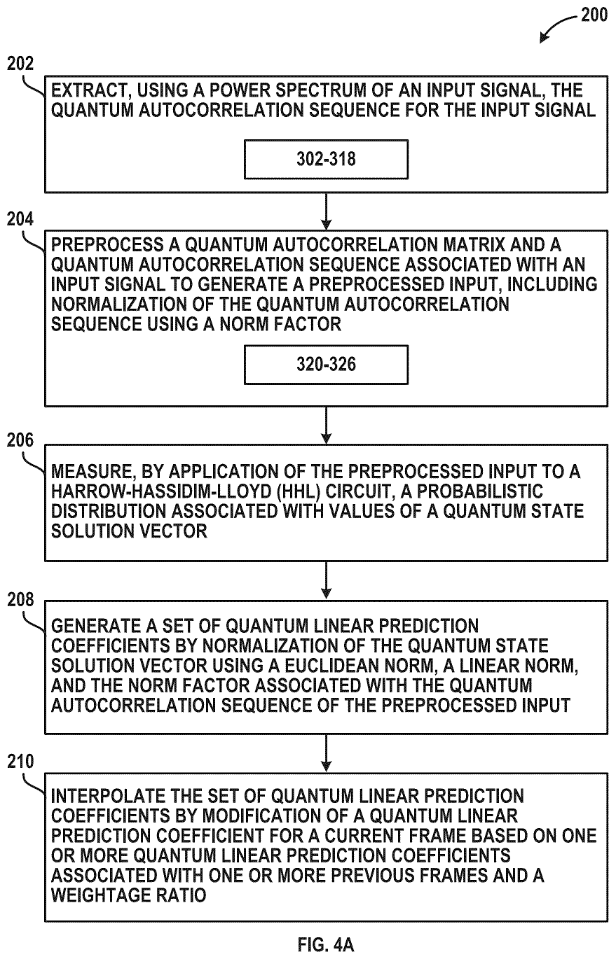

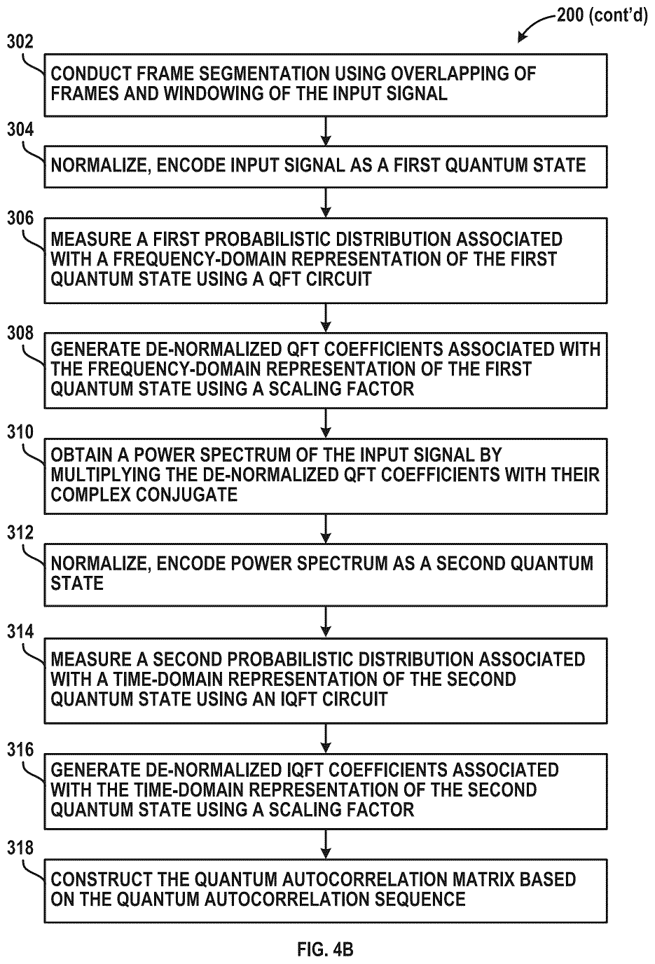

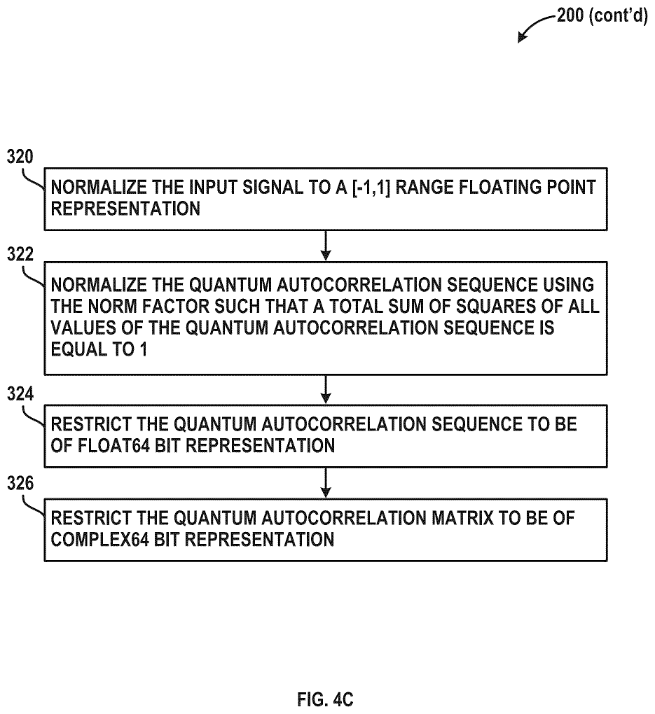

FIGS. 4A-4C illustrate a method 200 for obtaining quantum linear prediction coefficients of an input signal.

Referring to FIG. 4A, step 202 of method 200 can include extracting, using a power spectrum of an input signal, the quantum autocorrelation sequence and the quantum autocorrelation matrix for the input signal. The system 100 can obtain the quantum autocorrelation sequence and/or the quantum autocorrelation matrix from another component, or can obtain the quantum autocorrelation sequence and/or the quantum autocorrelation matrix using the computing device 102 in conjunction with quantum autocorrelation circuits 10 shown in FIG. 1A. Step 202 of method 200 can encompass steps 302-318 shown in FIG. 4B.

Step 204 of method 200 shown in FIG. 4A can include preprocessing (e.g., by computing device 102) a quantum autocorrelation matrix and the quantum autocorrelation sequence associated with the input signal to generate a preprocessed input, including normalization of the quantum autocorrelation sequence using a norm factor. The preprocessed input can include the (preprocessed) quantum autocorrelation matrix as a matrix “A” and the (preprocessed) quantum autocorrelation sequence as a vector “b”. Step 204 of method 200 can encompass steps 320-326 shown in FIG. 4C.

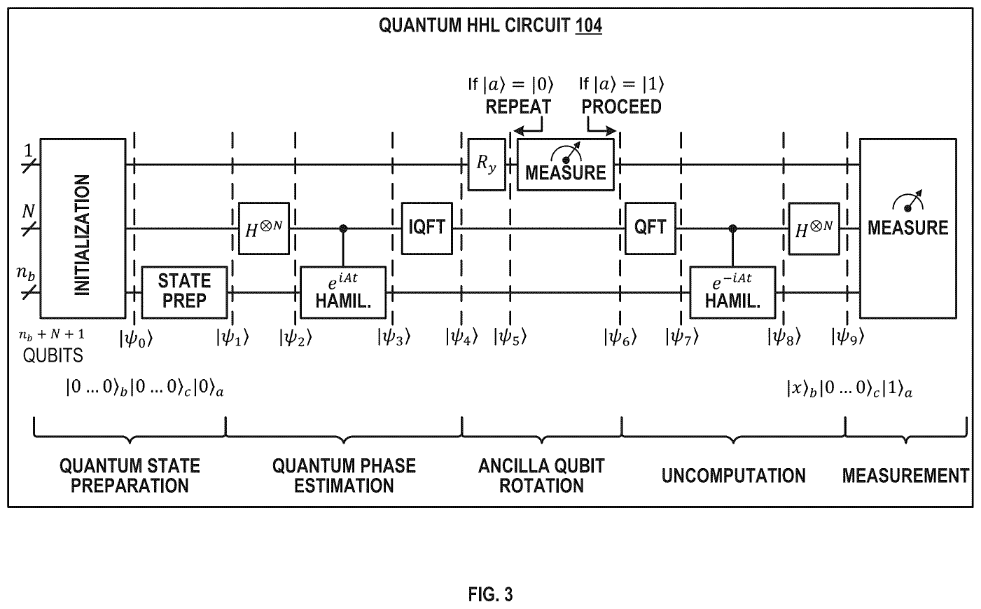

Step 206 of method 200 shown in FIG. 4A can include measuring, by application of the preprocessed input to a Quantum HHL circuit 104 shown in FIGS. 1A and 3, a probabilistic distribution associated with values of a quantum state solution vector using a Harrow-Hassidim-Lloyd (HHL) circuit. The quantum state solution vector represents a set of quantum autoregressive parameters that correlate with a linear relationship between the quantum autocorrelation matrix and the quantum autocorrelation sequence. As such, the quantum state solution vector can be considered to be a vector “x”, which is a solution to the linear system Ax=b.

Step 208 of method 200 can include generating (e.g., by computing device 102) a set of quantum linear prediction coefficients by normalization of the quantum state solution vector (“x” vector) using a Euclidean norm and a linear norm, as well as the norm factor associated with the quantum autocorrelation sequence of the preprocessed input. Normalizing the quantum state solution vector corresponds with “post-processing” illustrated in FIGS. 1A and 1B.

Step 210 of method 200 can include interpolating the set of quantum linear prediction coefficients by modification of a quantum linear prediction coefficient for a current frame based on one or more quantum linear prediction coefficients associated with one or more previous frames and a weightage ratio.

Referring to FIG. 4B, steps 302-318 of method 200 elaborate on step 202 shown in FIG. 4A pertaining to extracting the quantum autocorrelation sequence and the quantum autocorrelation matrix for the input signal.

Step 302 of method 200 includes conducting frame segmentation using overlapping of frames and windowing of the input signal prior to normalization of the input signal. Step 304 of method 200 includes normalizing and encoding the input signal as a first quantum state, where normalization as in step 304 can be achieved using computing device 102 and where encoding can be achieved using quantum encoding circuit 12 of the quantum autocorrelation circuits 10 shown in FIG. 1A. Step 306 of method 200 includes measuring a first probabilistic distribution associated with a frequency-domain representation of the first quantum state using the QFT circuit 14 of the quantum autocorrelation circuits 10 shown in FIG. 1A. Step 308 of method 200 includes generating (e.g., by computing device 102) de-normalized QFT coefficients associated with the frequency-domain representation of the first quantum state using a scaling factor that incorporates a norm and a quantity of qubits. Step 310 of method 200 includes obtaining a power spectrum of the input signal by multiplying the de-normalized QFT coefficients with a complex conjugate of the de-normalized QFT coefficients.

Continuing with FIG. 4B, step 312 of method 200 includes normalizing and encoding the power spectrum of the input signal as a second quantum state, where normalization as in step 312 can be achieved using computing device 102 and where encoding can be achieved using quantum encoding circuit 12 of the quantum autocorrelation circuits 10 shown in FIG. 1A. Step 314 of method 200 includes measuring a second probabilistic distribution associated with a time-domain representation of the second quantum state using the IQFT circuit 14 of the quantum autocorrelation circuits 10 shown in FIG. 1A. Step 316 of method 200 includes generating (e.g., by computing device 102) de-normalized IQFT coefficients associated with the time-domain representation of the second quantum state using a scaling factor that incorporates a norm and a quantity of qubits. Step 318 of method 200 includes constructing the quantum autocorrelation matrix based on the quantum autocorrelation sequence.

Referring to FIG. 4C, steps 320-326 of method 200 elaborate on step 204 shown in FIG. 4A pertaining to pre-processing the quantum autocorrelation matrix and a quantum autocorrelation sequence prior to measurement at the Quantum HHL Circuit 104 of FIG. 1A.

Step 320 of method 200 includes normalizing the input signal to a [−1,1] range floating point representation. Step 322 of method 200 includes normalizing the quantum autocorrelation sequence (“b” vector) using a norm factor such that a total sum of squares of all values of the quantum autocorrelation sequence is equal to 1.

Step 324 of method 200 includes restricting the quantum autocorrelation sequence (“b” vector) to be of float64 bit representation. Further, step 326 of method 200 includes restricting the quantum autocorrelation matrix (“A” vector) to be of complex64 bit representation. Note that in some examples, steps 324 and 326 may be optional.

### Computing Device

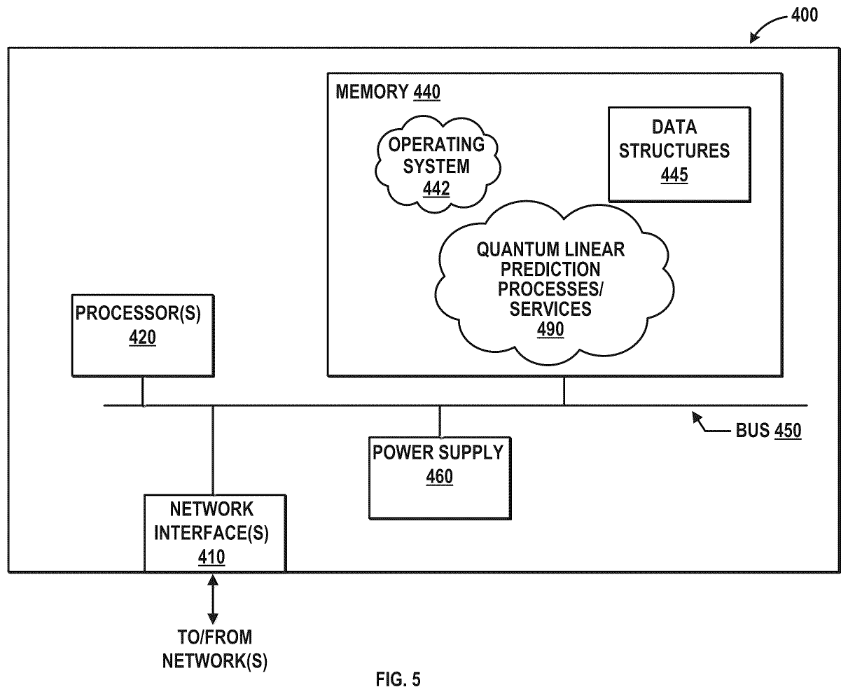

FIG. 5 is a schematic block diagram of an example device 400 that may be used with one or more embodiments described herein, e.g., as a component of computing device 102 of FIG. 1A, which can be a classical computing device. In other examples, device 400 can be a quantum computing device. Device 400, as computing device 102 of FIG. 1A, can communicate with the quantum circuits shown in FIG. 1A including but not limited to the Quantum HHL circuit 104 and quantum autocorrelation circuits 10.

Device 400 comprises one or more network interfaces 410 (e.g., wired, wireless, PLC, etc.), at least one processor 420, and a memory 440 interconnected by a system bus 450, as well as a power supply 460 (e.g., battery, plug-in, etc.).

Network interface(s) 410 include the mechanical, electrical, and signaling circuitry for communicating data over the communication links coupled to a communication network. Network interfaces 410 are configured to transmit and/or receive data using a variety of different communication protocols. As illustrated, the box representing network interfaces 410 is shown for simplicity, and it is appreciated that such interfaces may represent different types of network connections such as wireless and wired (physical) connections. Network interfaces 410 are shown separately from power supply 460, however it is appreciated that the interfaces that support PLC protocols may communicate through power supply 460 and/or may be an integral component coupled to power supply 460.

Memory 440 includes a plurality of storage locations that are addressable by processor 420 and network interfaces 410 for storing software programs and data structures associated with the embodiments described herein. In some embodiments, device 400 may have limited memory or no memory (e.g., no memory for storage other than for programs/processes operating on the device and associated caches). Memory 440 can include instructions executable by the processor 420 that, when executed by the processor 420, cause the processor 420 to implement aspects of the system 100 and the method 200 outlined herein.

Processor 420 comprises hardware elements or logic adapted to execute the software programs (e.g., instructions) and manipulate data structures 445. An operating system 442, portions of which are typically resident in memory 440 and executed by the processor, functionally organizes device 400 by, inter alia, invoking operations in support of software processes and/or services executing on the device. These software processes and/or services may include quantum linear prediction processes/services 490, which can include aspects of method 200 and/or implementations of various modules described herein. Note that while quantum linear prediction processes/services 490 is illustrated in centralized memory 440, alternative embodiments provide for the process to be operated within the network interfaces 410, such as a component of a MAC layer, and/or as part of a distributed computing network environment. Memory 440 can include non-transitory computer readable media including instructions encoded thereon that are executable by the processor 420 to implement quantum linear prediction processes/services 490 (e.g., which can include aspects of method 200, particularly those which are to be implemented by computing device 102).

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the quantum linear prediction processes/services 490 is shown as a standalone process, those skilled in the art will appreciate that this process may be executed as a routine or module within other processes.

### Comparative Results

This section examines the effect of increasing the number of qubits in the systems and methods outlined herein for computing quantum solutions of linear equations. Performance of the system is analyzed for sparse and dense linear equations and linear equations obtained from speech signals.

### Results for Solution of Sparse and Dense Linear Equations

First, the effect of the sparsity of linear equations on the computation of quantum solutions using the systems outlined herein are demonstrated. A comparison is made for classical and quantum solutions by calculating the MSE for different levels of density of the matrix. Further, this section examines the effects of denser matrices having a large number of non-zero entries, leading to increased complexity in the HHL computation. The restriction of bit precision in preprocessing stage for the quantum solution computation, results in subsequently higher MSE values for denser matrices (higher D value) as seen in Table 1. The modified quantum HHL methods are also examined for different matrix sizes (different number of qubits to represent the matrix). It is seen in Table 2 that the MSE increases with an increase in the number of qubits for both sparse and dense matrices. This is because HHL only returns a good approximation of |x) the quantum state of the exact solution, and the complexity of HHL is enlarged by the norm of the classical solution, which increases by the complexity of the matrix. With the increase in matrix size and the number of qubits, the complexity of the quantum circuit is increased, resulting in larger MSE values. These results demonstrate the tradeoff between matrix density, large matrix sizes, and accuracy in the application of the HHL methods outlined herein.

TABLE 1
MSE comparing classical vs quantum HHL solution
for different matrix sizes and matrix density.

| | | |
|---|---|---|
| Matrix | Total | MSE for matrix with different density |

| Size | Qubits | D = 0.3 | D = 0.6 | D = 0.9 |
|---|---|---|---|---|
| 2x2 | 5 | 1.060e−29 | 1.4757e−7 | 0.000096 |
| 4x4 | 7 | 0.0000030 | 0.000013 | 0.000249 |
| 8x8 | 9 | 0.0000448 | 0.000061 | 0.004811 |

### Effects of Speech Signal Qubits on the Modified HHL Accuracy

Further, this section presents an analysis of the effect of varying number of speech signal qubits on the modified HHL algorithm output. MSE values of the solution of linear equations are calculated based on results from quantum autocorrelation and classical autocorrelation methods. These are the dense matrices constructed from the speech signal which are bit restricted during the preprocessing stage of quantum HHL computation. As a result, Table 2 shows an increase in MSE as the qubits used to represent quantum speech signal is increased. This increase in MSE observed is because of the restriction of input values to a float64 representation, resulting in the introduction of rounding-off errors. These errors can propagate through the computation with an increasing number of qubits contributing to the increased MSE. Therefore, the performance and complexity of quantum computations involving speech signal processing get worse with increasing qubits.

TABLE 2
MSE comparing classical vs quantum solution for 4x4 matrix
with different number of qubits representing speech signal.

| Qubits | 5 | 6 | 7 | 8 |
|---|---|---|---|---|
| MSE | 0.0000182 | 0.0001611 | 0.000304 | 0.000876 |

### Application Results

This section investigates the effectiveness of the quantum linear prediction algorithm in signal processing applications, specifically for system identification, spectral estimation, and speech analysis. In particular, this section analyzes the performance of the QLP algorithm and its comparison with the classical linear prediction (CLP) for the above-mentioned signal processing applications.

### Synthetic Results for System Identification

Linear prediction is a widely used technique in system identification, which aims to estimate the parameters of a linear system by modeling the signal as a linear combination of its previous samples, using an “autoregressive” (AR) model. The estimated AR parameters are used to characterize the transfer function of an unknown system only from output observations. For this, a synthetic system is presented with a transfer function,

$$H ( z ) = \frac{1}{1 - 0.24 {z}^{- 1} + 1.544 {z}^{- 2} - 0.21 {z}^{- 3} - 1.1 {z}^{- 4}} \qquad ( 9 )$$

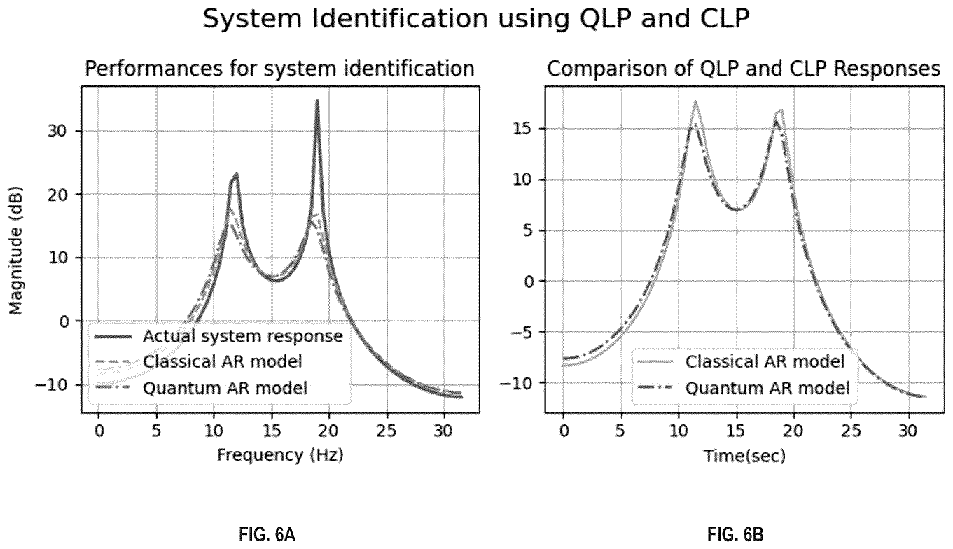

The system is assumed to be excited by white noise. We then compared the actual frequency response of the system with the expected frequency responses derived from the classical AR model and the quantum AR model as shown in FIGS. 6A and 6B. By analyzing the frequency responses, observe that CLP and QLP estimated the system parameters. Also, the close alignment between the two curves (FIG. 6B) indicates that the quantum AR model performs as well as the classical AR model, with almost overlapping frequency responses.

This comparison was based on the specific synthetic system h(z) used in this research. Different coefficient values can yield AR parameters; however, the quantum and classical AR parameter values will be close.

### Results for AR Spectral Estimation

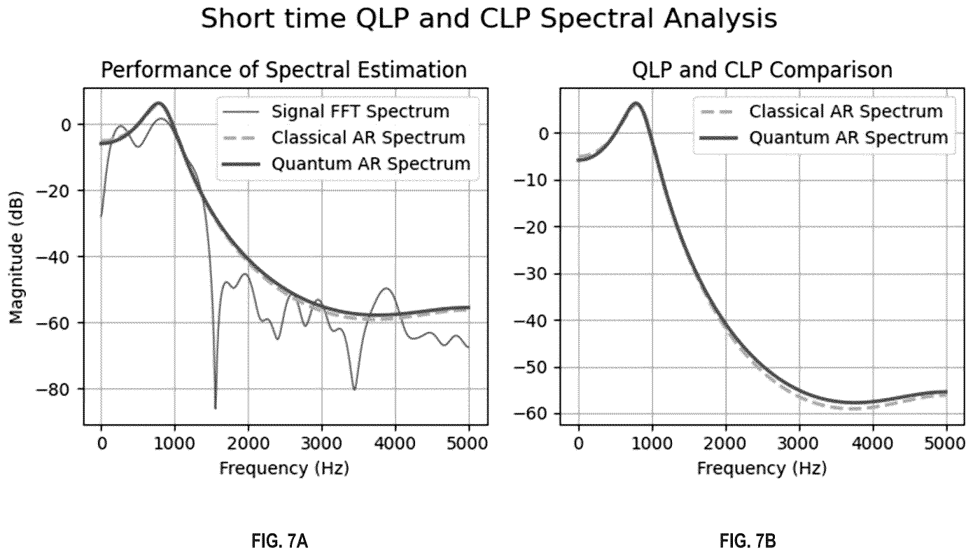

This section examines quantum linear prediction for AR spectral estimation, to estimate the power spectrum of a given speech signal using the AR model. In particular, this section compares the classical AR spectrum obtained through CLP, and the quantum AR spectrum obtained through QLP. One such example of spectral estimation for a frame signal is shown in FIGS. 7A and 7B, from which one can observe that both the quantum AR spectrum and the classical AR spectrum closely follow the envelope of the input signal's spectrum. Additionally, one can observe that the quantum AR spectrum captures the shape of the input signal's spectrum, and closely resembles the classical estimation results with MSE=0.927 calculated between CLP and QLP results. Since spectral magnitudes are expressed in dB, these MSE values are calculated in a logarithmic scale. Therefore, the developed QLP model performs well for such low order spectral fitting.

### Results of Speech Analysis Synthesis

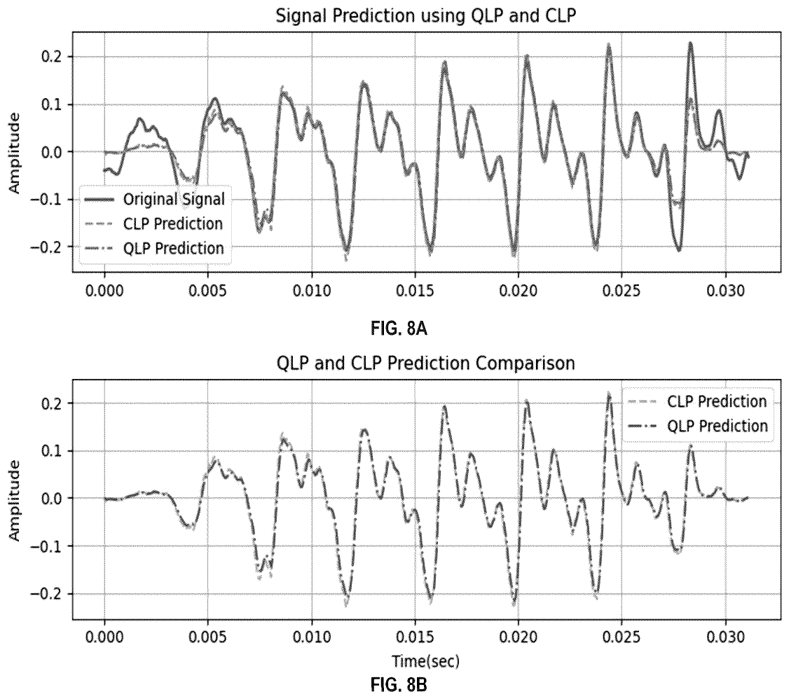

To evaluate the performance of QLP for speech analysis-synthesis, this section shows mean square error (MSE) for quantifying the difference between the original and synthesized speech signals. This provided a measure of reconstruction accuracy for QLP and CLP results. Speech prediction using QLP and CLP for a speech segment of 10 frames combined is shown in FIGS. 8A and 8B, with the MSE values for CLP speech prediction=0.00061 and QLP speech prediction=0.00075. FIGS. 8A and 8B and the MSE demonstrate that the QLP approach has a similar prediction as obtained using CLP with a similar MSE.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method, comprising:
preprocessing a quantum autocorrelation matrix and a quantum autocorrelation sequence associated with an input signal to generate a preprocessed input, including normalization of the quantum autocorrelation sequence using a norm factor;
measuring, by application of the preprocessed input to a Harrow-Hassidim-Lloyd (HHL) circuit, a probabilistic distribution associated with values of a quantum state solution vector; and
generating a set of quantum linear prediction coefficients by re-normalization of the quantum state solution vector using the norm factor associated with the quantum autocorrelation sequence of the preprocessed input.

2. The method of claim 1, the quantum state solution vector representing a set of quantum autoregressive parameters that correlate with a linear relationship between the quantum autocorrelation matrix and the quantum autocorrelation sequence.

3. The method of claim 1, further comprising:
interpolating the set of quantum linear prediction coefficients by modification of a quantum linear prediction coefficient for a current frame based on one or more quantum linear prediction coefficients associated with one or more previous frames and a weightage ratio.

4. The method of claim 1, further comprising:
normalizing the input signal to a [−1,1] range floating point representation.

5. The method of claim 1, further comprising:
conducting frame segmentation using overlapping of frames and windowing of the input signal prior to normalization of the input signal.

6. The method of claim 1, further comprising:
normalizing the quantum autocorrelation sequence using the norm factor such that a total sum of squares of all values of the quantum autocorrelation sequence is equal to 1.

7. The method of claim 1, re-normalization of the quantum state solution vector further including:
normalizing the quantum state solution vector using a Euclidean norm and a linear norm.

8. The method of claim 1, further comprising:
restricting the quantum autocorrelation matrix to be of complex64 bit representation; and
restricting the quantum autocorrelation sequence to be of float64 bit representation.

9. The method of claim 1, further comprising:
extracting, using a power spectrum of the input signal, the quantum autocorrelation sequence for the input signal.

10. The method of claim 9, further comprising:
normalizing and encoding the input signal as a first quantum state;
measuring a first probabilistic distribution associated with a frequency-domain representation of the first quantum state using a Quantum Fourier Transform (QFT) circuit;
generating de-normalized QFT coefficients associated with the frequency-domain representation of the first quantum state using a scaling factor that incorporates a norm and a quantity of qubits; and
obtaining the power spectrum of the input signal by multiplying the de-normalized QFT coefficients with a complex conjugate of the de-normalized QFT coefficients.

11. The method of claim 9, further comprising:
normalizing and encoding a power spectrum of the input signal as a second quantum state, the power spectrum being obtained from de-normalized (QFT) coefficients associated with a frequency-domain representation of the input signal;
measuring a second probabilistic distribution associated with a time-domain representation of the second quantum state using an Inverse Quantum Fourier Transform (IQFT) circuit; and
generating de-normalized IQFT coefficients associated with the time-domain representation of the second quantum state using a scaling factor that incorporates a norm and a quantity of qubits.

12. The method of claim 9, further comprising:
constructing the quantum autocorrelation matrix based on the quantum autocorrelation sequence.

13. The method of claim 1, the input signal including a speech signal.

14. A system, comprising:
a computing device in communication with a Harrow-Hassidim-Lloyd (HHL) circuit, the computing device including a processor and a memory, the memory including instructions executable by the processor to:
preprocess a quantum autocorrelation matrix and a quantum autocorrelation sequence associated with an input signal to generate a preprocessed input, including normalization of the quantum autocorrelation sequence using a norm factor;
measure, by application of the preprocessed input to the Harrow-Hassidim-Lloyd (HHL) circuit, a probabilistic distribution associated with values of a quantum state solution vector; and
generate a set of quantum linear prediction coefficients by re-normalization of the quantum state solution vector using the norm factor associated with the quantum autocorrelation sequence of the preprocessed input.

15. The system of claim 14, the quantum state solution vector representing a set of quantum autoregressive parameters that correlate with a linear relationship between the quantum autocorrelation matrix and the quantum autocorrelation sequence.

16. The system of claim 14, the computing device further including instructions executable by the processor to:
interpolate the set of quantum linear prediction coefficients by modification of a quantum linear prediction coefficient for a current frame based on one or more quantum linear prediction coefficients associated with one or more previous frames and a weightage ratio.

17. The system of claim 14, the computing device further including instructions executable by the processor to:
normalize the input signal to a [−1,1] range floating point representation.

18. The system of claim 14, the input signal including a speech signal.

19. A non-transitory computer-readable medium including instructions encoded thereon, the instructions being executable by a processor to:
preprocess a quantum autocorrelation matrix and a quantum autocorrelation sequence associated with an input signal to generate a preprocessed input, including normalization of the quantum autocorrelation sequence using a norm factor;
measure, by application of the preprocessed input to a Harrow-Hassidim-Lloyd (HHL) circuit, a probabilistic distribution associated with values of a quantum state solution vector, the quantum state solution vector representing a set of quantum autoregressive parameters that correlate with a linear relationship between the quantum autocorrelation matrix and the quantum autocorrelation sequence; and
generate a set of quantum linear prediction coefficients by re-normalization of the quantum state solution vector using the norm factor associated with the quantum autocorrelation sequence of the preprocessed input.

20. The non-transitory computer-readable medium of claim 19, further including instructions encoded thereon, the instructions being executable by the processor to:
normalize the input signal to a [−1,1] range floating point representation.
